(19) United States
(12) Patent Application Publication
(10) Pub. No.: US 2019/0032967 A1
(43) Pub. Date: Jan. 31, 2019

(54) IONIC FLUID / CO2 COFLUID REFRIGERATION SYSTEM

(71) Applicants: Tecumseh Products Company, Inc., Ann Arbor, MI (US); Ionic Research Technologies, LLC, South Bend, IN (US)

(72) Inventors: Akash Bhatia, Ann Arbor, MI (US); Cassio Ricardo Naidhig Maule, Ann Arbor, MI (US); Marcelo Alexandre Real, Ann Arbor, MI (US); Douglas T. Morrison, South Bend, IN (US); Mauricio Quiroz-Guzman, South Bend, IN (US)

(21) Appl. No.: 15/659,118

(22) Filed: Jul. 25, 2017

(51) Int. Cl. F25B 9/00; C09K 5/04; F25B 31/00; F25B 31/02

(52) U.S. Cl. CPC F25B 9/008; C09K 5/041; F25B 2400/054; F25B 31/023; F25B 31/002

(57) ABSTRACT

A refrigerant system uses a cofluid of ionic liquid and CO₂ as a working fluid, and is adapted to selectively bind and release CO₂ molecules from the ionic fluid in exothermic and endothermic processes, respectively. The refrigerant system includes a hermetic compressor which acts as a pump for the substantially uncompressible liquid working fluid. The compressor includes electrical components (such as the electric motor and various wires and connectors) which are electrically isolated from the working fluid in order to prevent electrical shorts caused by the conductive ionic fluid. At the same time, the ionic liquid may act as a lubricating fluid for the compressor components, eliminating any need for separate working and lubricating fluids.

### FIELD OF THE DISCLOSURE

The present disclosure relates to hermetically sealed compressors and, more particularly, to rotary compressors adapted for use with ionic fluid and low-pressure carbon dioxide as a working fluid.

### BACKGROUND

Vapor compression systems are used for controlling temperature and humidity within conditioned spaces. In the residential context, such systems take the form of air conditioners used to cool the air of a living space to a temperature below the ambient temperature outside the residence. In industrial or other refrigeration applications, vapor compression systems are used to cool and condition the air within coolers or freezers, such as for cooling and/or preservation of food, medicine, or other perishable products.

Basic vapor compression refrigeration systems utilize a compressor, condenser, expansion valve and evaporator connected in serial fluid communication with one another to form an air conditioning or refrigeration circuit. A quantity of compressible and condensable hydrofluorocarbon (HFC) refrigerant is commonly used in such refrigeration systems, such as 1,1,1,2-tetrafluoroethane (R134a) or other similar compositions such as R404 or R517 refrigerant. This HFC refrigerant is circulated through the system at varying temperatures and pressures, and is allowed to absorb heat at one stage of the system (e.g., within the cooled, conditioned space), and to reject the absorbed heat at another system stage (e.g., to the ambient air outside the cooled conditioned space). In the basic vapor compression refrigeration system, the evaporator is located within the conditioned space. Warm fluid, typically in the form of a liquid, is fed to the expansion valve, where the liquid is allowed to expand into a cold mixed liquid-vapor state. This cold fluid is then fed to an evaporator within the conditioned space.

HFC refrigerants, when exposed to ambient temperatures and pressures, evaporate and discharge to the general atmosphere, where they act as significant “greenhouse” gases. Because vapor compression systems have the potential to develop leaks in the refrigerant circuit at some point during the service life of the system, HFC refrigerants are increasingly disfavored for environmental reasons.

Carbon dioxide (CO₂) can be used for vapor compression systems, and is considered substantially more environmentally friendly because CO₂ has substantially less greenhouse potential than a comparable amount of HFC refrigerant and is otherwise considered environmentally benign. In this manner, a key advantage of the use of CO₂ refrigerant is that leaks of CO₂ refrigerant are not generally considered to be of concern, as opposed to leaks of traditional refrigerants. However, CO₂ condenses to liquid form only at pressures considerably higher than HFC refrigerant, such that vapor compression systems utilizing CO₂ require compressors, fittings, and other components capable of generating and containing high pressures. This, in turn, increases the cost to build and operate such a system.

What is needed is an improvement over the foregoing.

### SUMMARY

The present disclosure provides a refrigerant system which uses a cofluid of ionic liquid and CO₂ as a working fluid, in which the system is adapted to selectively bind and release CO₂ molecules from the ionic fluid in exothermic and endothermic processes, respectively. The refrigerant system includes a hermetic compressor which acts as a pump for the substantially uncompressible liquid working fluid. The compressor includes electrical components (such as the electric motor and various wires and connectors) which are electrically isolated from the working fluid in order to prevent electrical shorts caused by the conductive ionic fluid. At the same time, the ionic liquid may act as a lubricating fluid for the compressor components, eliminating any need for separate working and lubricating fluids.

In one form thereof, the present disclosure provides a refrigeration system including: a compressor having a housing and an electric motor hermetically sealed within the housing; a condenser; an expansion valve; an evaporator; and a quantity of working fluid comprising an electrically conductive ionic liquid and carbon dioxide, the working fluid circulatable through a series of fluid conduits interconnecting the compressor, the condenser, the evaporator and the expansion valve.

In another form thereof, the present disclosure provides a compressor for use with an electrically conductive working fluid, the compressor including a housing having an inlet and an outlet, and an electric motor hermetically sealed within the housing and electrically isolated from the interior of the housing.

### BRIEF DESCRIPTION OF THE DRAWINGS

The above mentioned and other features and objects of this disclosure, and the manner of attaining them, will become more apparent and the disclosure itself will be better understood by reference to the following description of exemplary embodiments of the disclosure taken in conjunction with the accompanying drawings, wherein:

FIG. 1 is a schematic diagram of a refrigeration system in accordance with the present disclosure;

FIG. 2 is a perspective view of a compressor in accordance with the present disclosure, with the compressor housing shown in dashed lines to illustrate the internal compressor components in the housing;

FIG. 3 is an exploded, perspective view of the compressor shown in FIG. 2;

FIG. 4 is an elevation, section view of a motor stator in accordance with the present disclosure, including coated motor windings; and

FIG. 5 is an exploded, perspective view of a hermetic terminal assembly in accordance with the present disclosure, including encapsulated electrical connectors.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplification set out herein illustrates exemplary embodiments of the disclosure, in various forms, and such exemplifications are not to be construed as limiting the scope of the disclosure in any manner.

### DETAILED DESCRIPTION

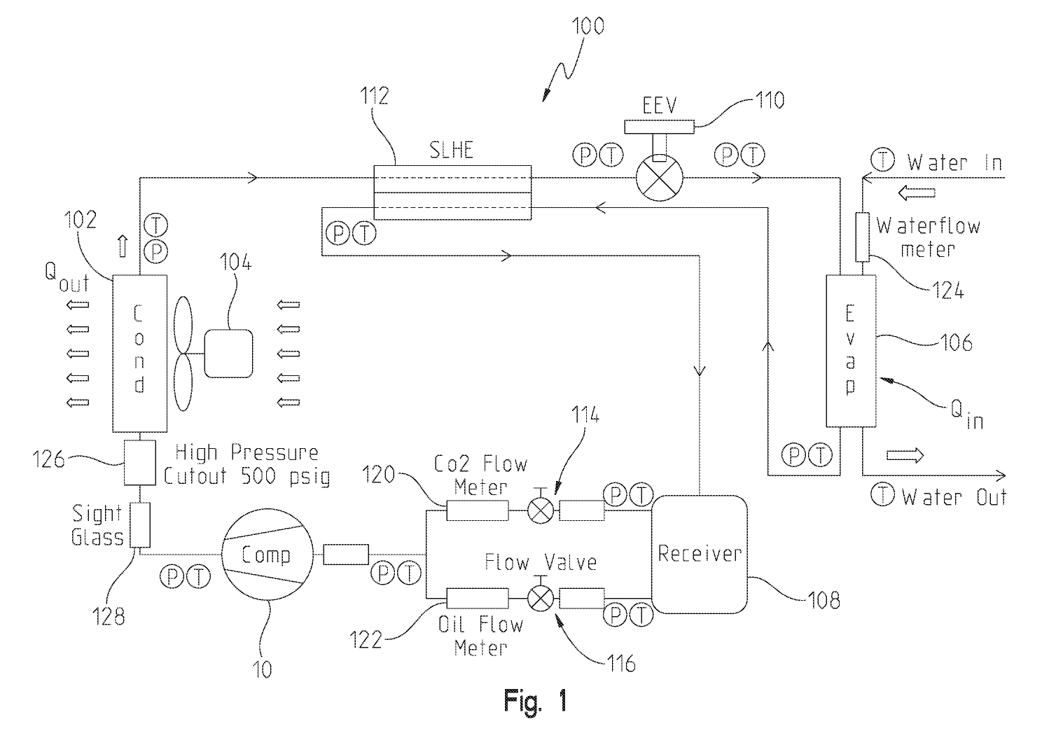

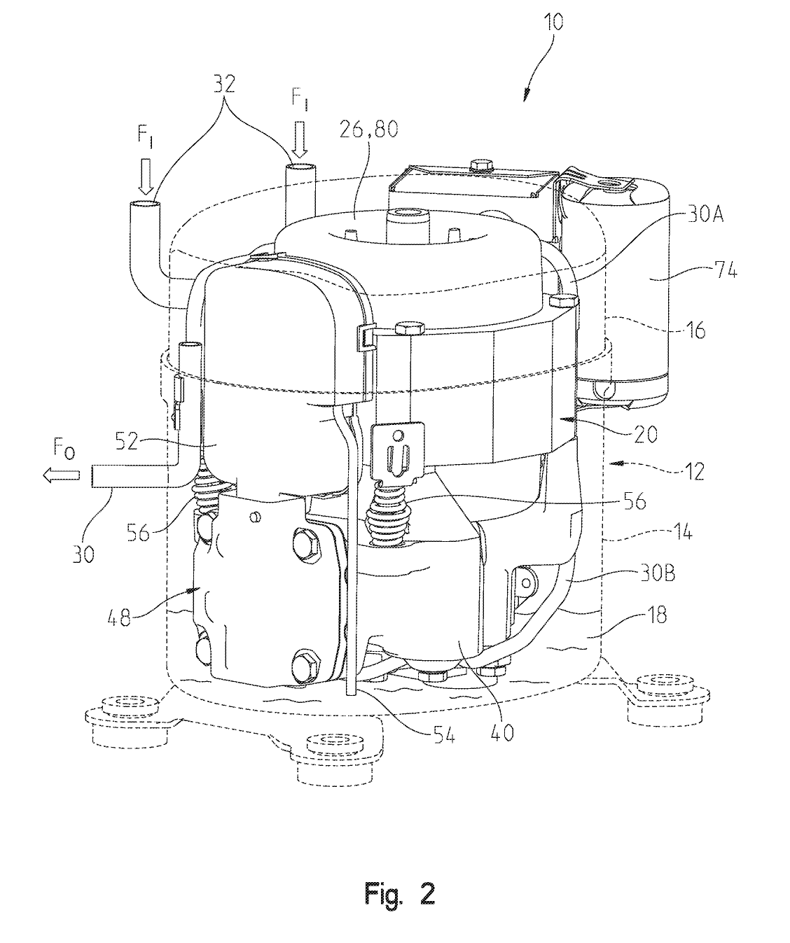

The present disclosure provides refrigeration system 100, shown in FIG. 1, in which the working fluid is a quantity of cofluid 18 (FIG. 2) including a conductive ionic liquid and carbon dioxide (CO₂) gas. The cofluid is circulated through the components of refrigeration system 100 at relatively low pressures, as the CO₂ molecules are selectively bound to the ionic liquid in an exothermic reaction within condenser 102, and released from the ionic liquid in an endothermic reaction within evaporator 106. Compressor 10 of system 100 has interior electrical components that are electrically insulated such that the electrically conductive cofluid can serve both the working fluid and the lubrication fluid during operation of compressor 10.

The embodiment disclosed below is not intended to be exhaustive or limit the disclosure to the precise form disclosed in the following detailed description. Rather, the embodiments are chosen and described so that others skilled in the art may utilize its teachings.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

1. Cofluid Compressor

Turning to FIG. 2, compressor 10 is shown fully assembled with a quantity of cofluid 18 accumulated in a sump region at the bottom of housing body 14 of housing 12 (housing 12 is shown clear and in dashed lines in order to illustrate the internal components received therein). As described in detail below, compressor 10 uses cofluid 18 as a working fluid, operating to pump the ionic liquid component of cofluid 18, and to compress the gaseous CO₂ component of cofluid 18. This compression selectively induces exothermic binding of the CO₂ molecules to the cations of the liquid. The cofluid 18 (specifically, the ionic liquid) also acts as a lubricating fluid for the mechanical and/or moving parts of the compressor, as further detailed below.

Compressor 10 operates as a hermetic compressor, in that housing 12 forms a sealed chamber which does not admit fluid passage except through the designated channels, i.e., inlets 32 and outlet 30. In particular, housing body 14 contains various internal components of compressor 10, and housing lid 16 is received on housing body 14 to seal the internal cavity. Contained and sealed within the hermetic chamber of housing 12 are electric motor 20 and the associated support, reciprocating and noise/vibration-reducing components of compressor 10, as detailed below. Electrical components not necessary for inclusion within housing 12 are mounted to the outside, such as electrical input assembly 60 and capacitor assembly 70. For electrical components within housing 12 (e.g., parts of motor 20 and the interior electrical connections), electrical insulation is provided to enable the use of ionic liquid, as also described further below. In this way, the hermetic chamber of housing 12 encloses both motor 20 and the other components of the compression mechanism, such that working fluid (i.e., cofluid 18) functionally interacting with the motor and compressor mechanism is only sourced from one or both of inlets 32 and only discharged to outlet 30. In particular, both the liquid and gaseous components of cofluid 18 travel together through one or both of inlets 32, are compressed and/or pumped by the motor 20 and other compressor parts of compressor 10 within the hermetic chamber of housing 12, and are discharged together from the hermetic chamber via outlet 30.

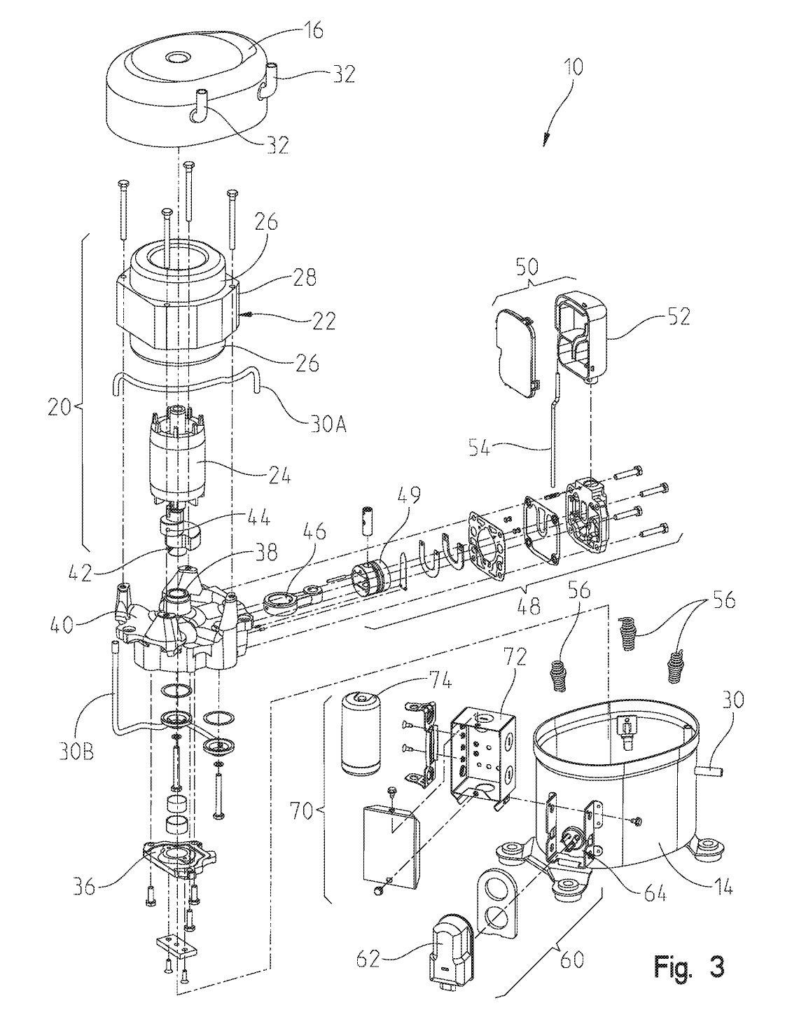

FIG. 3 shows an exploded view of compressor 10 illustrating its various parts and subsystems. Compressor base 40 supports stator 22, which is fixed to base 40 via a series of bolts. Rotor 24 is received within stator 22 in a driving relationship to form electric motor 20, which utilizes electrical fields generated in windings 26 to rotate rotor 24. This rotation drives drive shaft 42, thereby rotating eccentric 44. When assembled, eccentric 44 is received within a corresponding collar formed in connecting rod 46, such that rotation of drive shaft 42 reciprocates connecting rod 46, driving piston 49 along its stroke within piston assembly 48. Drive shaft 42 is supported by main bearing 38 in base 40, and by lower bearing 36 and an upper bearing (not shown) in housing lid 16. The entire assembly of motor 20, base 40 and the associated components is supported within housing on anti-vibration springs 56, which couple to base 40 and to the wall of housing body 14.

Thus, operation of motor 20 drives piston assembly 48 to generate negative pressure (vacuum) and positive pressure at opposite ends of the piston bore, in the manner of a conventional compressor. In the case of compressor 10, vacuum is created at suction assembly 50, which includes suction muffler 52 and cofluid suction tube 54. This vacuum causes suction tube 54, which has its lower end submerged in cofluid 18 in the sump region of housing body 14, to draw liquid into muffler 52. In an exemplary embodiment, the volume of cofluid 18 within the sump region of compressor 10 is maintained at a minimum amount to ensure that the lower end of suction tube 54 remains submerged regardless of the operating condition of compressor 10. This ensures continuous protection of the bearings and other moving parts of compressor 10 during operation, as described herein.

This liquid is then distributed into piston assembly 48 and on to into base 40 and around motor 20, lubricating the moving parts thereof and protecting against damage from friction and heat. Advantageously, the ionic liquid component of cofluid 18 is a lubricious material capable of this protective function, such that cofluid 18 can serve as both the lubrication fluid and the working fluid in refrigeration system 100 (described further below). In the illustrated embodiment of FIGS. 2 and 3, cofluid 18 serves to lubricate piston 49 and its associated moving parts, including the connection between connecting rod 46 and piston 49, as well as the connection between connecting rod 46 and drive shaft 42. The bearings supporting drive shaft 42 and motor 20, including bearings 36 and 38, may also be lubricated by cofluid 18. Because cofluid 18 is used as both a working fluid and a lubricating fluid, compressor 10 may lack traditional dedicated lubricating fluids, such as hydrocarbon oils, e.g., polyol ether oils and polyol ester oils.

In the illustrated embodiment, compressor 10 is a “low side” compressor design, in that motor 20 is located in the relatively low-pressure (i.e., suction pressure) intake region. In this context, the “intake region” is the region within housing 12 and functionally disposed between inlets 32 and piston assembly 48 (FIG. 3), which is at suction pressure. Alternatively, compressor 10 may be configured as a “high-side” design, in which the motor is located in the high-pressure discharge region. In this context, the “discharge region” is the region within housing 12 and functionally disposed between piston assembly 48 and outlet 30 (FIG. 3), which is at discharge pressure.

In an exemplary embodiment, cofluid 18 includes a nonfunctional diluent in addition to the ionic liquid and CO₂. For purposes of the present disclosure, a diluent is considered “nonfunctional” if it does not change the functional properties of the cofluid to which it is added. For example, the diluent added to cofluid 18 is formulated to avoid any substantial impact on the capacity of cofluid 18 for heat transfer. In particular, the diluent added to cofluid 18 is electrically non-conductive, and is also non-reactive with gaseous CO₂, such that the diluent has no significant impact on the selective absorption and desorption of CO₂ to the cations of the ionic liquid of cofluid 18, as described herein. In one exemplary embodiment, the addition of diluent to cofluid 18 effects a change in electrical conductivity (as compared to the ionic fluid alone) or less than a threshold nominal amount. This nominal threshold change (e.g., reduction) in electrical conductivity may be 2%, 5% or 10%, for example.

In its native form, ionic liquid may have a relatively high viscosity as compared to traditional refrigerant liquids and/or lubricants used in connection with compressors and other components in refrigeration systems. In order to render cofluid 18 compatible with standard, commercially available components used in connection with such traditional refrigeration systems, the nonfunctional diluent may be used to reduce the viscosity of cofluid 18 to a nominal value sufficiently close to traditional refrigerant liquid (e.g., R404 or R517) for effective use with such standard components, without otherwise altering the functional heat-transfer properties of cofluid 18. In an exemplary embodiment, the final viscosity of cofluid 18 may be as low as 30 centistoke, 50 centistoke or 80 centistoke and as high 100 centistoke, 200 centistoke or 300 centistoke, or may be any viscosity within any range defined by any of the foregoing values. Moreover, the viscosity of cofluid 18 may be temperature-dependent, such that the viscosity of cofluid 18 increases at temperature decreases. In one particular embodiment, for example, cofluid 18 may have a viscosity of about 100 centistoke at around 10 C-14 C, which is a typical steady-state operating temperature for compressor 10. This same cofluid 18 may have a viscosity of about 36 centistoke at 40 C, 25 centistoke at 82 C and 295 centistoke at 0 C.

In an exemplary embodiment, tetraethylene glycol dimethyl ether (tetraglyme) is used as the diluent. Other suitable diluents may be selected on the basis of various factors relevant to use in the refrigeration system in which it will be used. For example, an exemplary diluent is liquid-phase at a relatively low pressure and has a relatively low viscosity, such that the diluent creates no substantial change to the phase change or viscosity characteristics of the ionic liquid. In addition, a solvent boiling point threshold of at least 150 degrees Celsius to ensure that the solvent will remain in a liquid phase at all the stages of the heat transfer process effected by refrigeration system 100.

Generally speaking, the diluent is chosen to have properties which do not significantly vary from those of the ionic liquid, such that the diluent will avoid functional participation in the system. Examples of glycol-based solvents suitable for incorporation into cofluid 18 include high boiling solvents comprising a glycol and/or an ether of a C₁ to C₄ alkyl which is miscible in water and alkoxysilanes. Such alkylene glycols may have a hydroxyl concentration of 0.021 mole/cm³ or less and a weight average molecular weight of about 100 or more. Examples of suitable high boiling solvent composition components include ethylene glycol, propylene glycol, di(ethylene)glycol, tri(ethylene)glycol, tetra(ethylene)glycol, penta(ethylene)glycol, di(propylene)glycol, hexa(ethylene)glycol, as well as alkyl ethers of any of the foregoing. A particularly suitable example is di(propylene)glycol methyl ether. Combinations of high boiling solvents may also be suitable. In yet another embodiment, low-viscosity compressor oil may be used as a diluent.

The amount of diluent used in cofluid 18 may vary depending on the characteristics of the diluent and ionic liquid, as compared to the characteristics (e.g., viscosity) of the desired final cofluid 18. In an exemplary embodiment, the amount of diluent may be as little as 5%, 10%, 12%, or 15% of the combined weight of the diluent and ionic liquid in the finished cofluid, or may be as much as 20%, 22%, 25%, 30% or 35%, of such combined weight, or may be any percentage within any range defined by any of the foregoing values. In one particular embodiment, for example, the diluent used in cofluid 18 may represent about 20% of the total weight of cofluid 18.

Electrical power is provided to compressor 10 via electrical input assembly 60, as shown in FIG. 3. Assembly 60 includes junction box 62 which houses the outer portion of hermetic terminal assembly 64, together with wiring and connectors interfacing therewith. Junction box 62 receives an electrical cable which conveys power to compressor (and particularly, to motor 20 as described further below) from an external source.

Electrical input assembly 60 may also include a separate electrical connection to capacitor assembly 70 outside of housing 12. Capacitor assembly 70 includes capacitor junction box 72, which receives electrical power from junction box 62 and provides the power to capacitor 74. Capacitor 74 provides a burst of high current which facilitates starting motor 20 from rest by overcoming inertia.

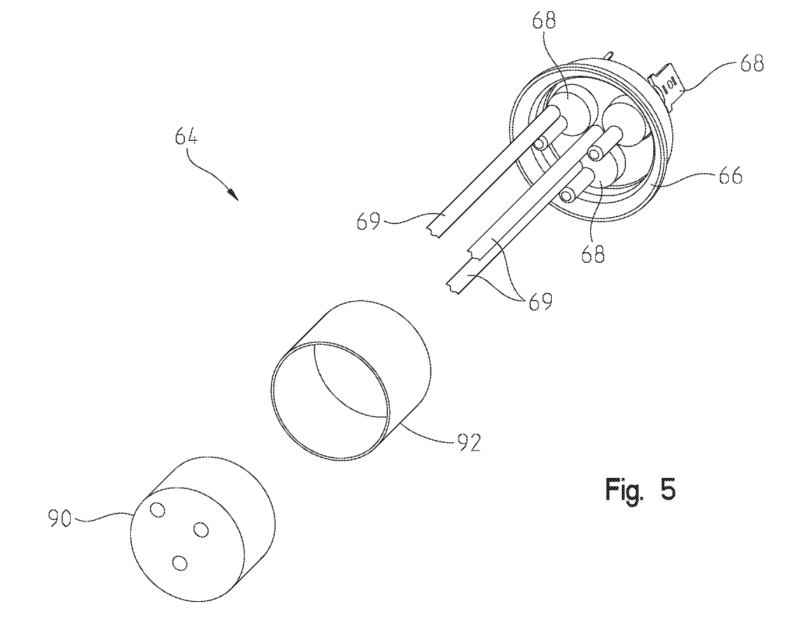

Electrical power is transmitted from the external power source and capacitor 74 via hermetic terminal assembly 64 best shown in FIG. 5. Terminal assembly 64 includes a bell-shaped terminal housing 66 which passes through an aperture in housing base 14 and tightly engages therewith to create a fluid-tight seal with the sidewall of housing base 14 while allowing electrical terminals 68 to pass therethrough. At the interior of housing 12, terminals 68 are connected to motor leads 69, which carry electrical power to motor 20 as further discussed below. Because the respective junctions between terminals 68 and motor leads 69 leave metal exposed to the interior of housing 12, the conductive cofluid 18 has the potential to contact these junctions and carry current across adjacent terminals 68. To avoid this, terminal assembly 64 includes insulation retainer 92 sealed to the interior of housing 66 to create a cylindrical cavity around terminals 68. This cavity is then filled with insulation 90, which may be a flowable electrical insulation that hardens after being exposed to air. One exemplary insulation material is polytetrafluoroethylene (PTFE), commercially available as Teflon® from The Chemours Company of Wilmington, Del., USA. Other exemplary insulation materials include alumina adhesive compounds, ceramic materials, or any other material which provides electrical insulation and is resistant to degradation from contact with to cofluid 18. In an exemplary embodiment, insulation materials include materials with a dielectric strength (i.e., the voltage required to produce a dielectric breakdown through the material) of at least 1500V for 1 minute for a given thickness of material used within the compressor. Exemplary insulation materials are also amenable to bonding to metal conductor materials such as copper.

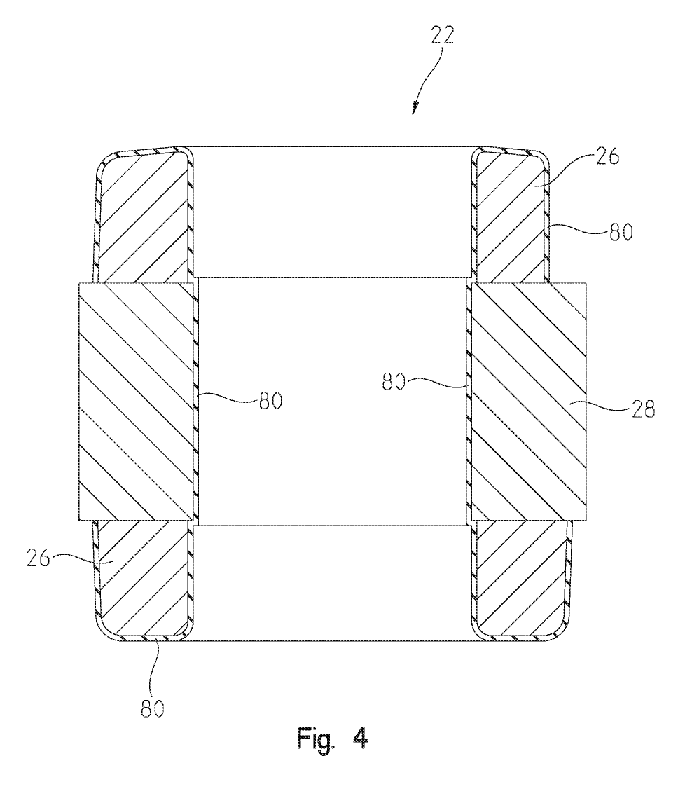

Motor 20 is also exposed to the electrical conductivity of the ionic fluid in cofluid 18, as noted above. Referring to FIG. 4, motor windings 26 are formed from a series of exposed conductive metal (e.g., copper) wires interleaved among winding retainer 28. In an exemplary embodiment, for example, retainer 28 is a series of steel plates laminated to one another and having to form a series of slots sized to receive the wires of windings 26. These wires extend above and below the retainer 28 to form a series of exposed copper loops that generate the magnetic field which induces rotor 24 (FIG. 3) to rotate when motor 20 is activated. In order to protect these windings from unintended electrical connections among the individual wires by contact with the electrically conductive ionic liquid of cofluid 18, stator 22 includes an electrically insulative coating 80 disposed between windings 26 and the interior of housing 12. As illustrated in FIG. 4, coating 80 extends over the interior, top and exterior portions of windings 26 extending above and below retainer 28, as well as along the interior of retainer 28 (e.g., within and among the slots within retainer 28 which contain individual wires of windings 26).

Like insulation 90 discussed above with respect to terminal assembly 64, coating 80 prevents direct contact between the ionic liquid of cofluid 18 and therefore prevents any electrical “arcing” or other unintended electrical connection between the respective wires of windings 26. The same insulation materials discussed above with respect to insulation 90 are suitable for coating 80.

In an alternative embodiment, coating 80 may be applied to the individual wires of windings 26 prior to their incorporation into motor 20. In particular, the wires may be coated with a polymeric material, such that each wire of windings 26 is electrically isolated from the ambient environment and the other adjacent wires. The polymeric coating material may be, for example, a thermoplastic elastomer or a melt-processible fluoropolymer. Suitable fluoropolymers include polytetrafluoroethylene (PTFE), methyl fluoro alkoxy (MFA), fluoro ethylene propylene (FEP), perfluoro alkoxy (PFA), poly(chlorotrifluoroethylene), poly(vinylfluoride), co-polymers of tetrafluoroethlyene and ethylene (ETFE), polyvinylidene fluoride (PVDF), and co-polymers of tetrafluoroethylene, hexafluoropropylene, and vinylidene difluoride (THV). The coating on the wires of windings 26 may also be formed by engineering resins or polymers. Suitable engineering polymers include PolyEther Ether Ketone (PEEK), PolyEther Sulphone (PES), PolyPhenylene Sulfide (PPS), PolyAmide Imide (PAI), Epoxy polymers, Polyester, Polyurethane (PU), Acrylic and PolyCarbonate (PC), for example.

Upon activation of compressor 10, motor 20 is powered via motor leads 69 inducing rotor 24 to start rotating. This rotation initiates reciprocation of connecting rod 46 and piston 47, as noted above, which initiates the compression and pumping of working fluid 18. In particular, a flow F₁ of cofluid 18 is drawn into the sump area of compressor 10 via one of inlets 32, and then into muffler 52 via suction tube 54. The suction created by piston assembly 48 draws the cofluid 18 from muffler 52 into piston assembly 48, lubricating the moving parts thereof. The gaseous CO₂ of cofluid 18 is then compressed, while the ionic liquid of cofluid 18 is pumped together with the compressed CO₂ to fluid lines 30A and 30B to reach the outlet 30. In the illustrated embodiment, one of the inlet tubes 32 is used for the inlet of cofluid 18, and the other is a “process tube” used for other purposes, such as the initial charging of compressor 10 with cofluid 18.

As further described below, refrigeration system 100 operates in a similar fashion to a traditional vapor compression system with similarly low pressures. Compressor 10 has a pressurization capacity in accordance with a “low pressure” refrigeration system such as system 100. As described in further detail below, a “low pressure” refrigeration system is one which operates at pressures typically associated with traditional vapor compression systems, such as between 2 bar (30 psi) and 50 bar (725 psi), for example. Therefore, compressor 10 has a pressurization capacity (i.e., the maximum pressure achievable at outlet 30) of about 50 bar (725 psi) or less. In an exemplary embodiment, compressor 10 has a maximum outlet pressure of about 40 bar.

As described in detail herein with respect to, e.g., FIGS. 2 and 3, compressor 10 is a hermetic compressor. This style of compressor is spatially efficient, has quiet operation, and integrates motor 20 and the other compressor components into a single package. These features and characteristics maintain a low cost of operation and enhance the reliability and longevity of refrigeration system 100. However, it is contemplated that other compressor designs can be utilized using the principles and teachings of the present disclosure, such as scroll compressors and other styles of reciprocating compressors.

Specifically, although compressor 10 is described herein as having a reciprocating piston-type compression mechanism, other compressor mechanisms may be used. For example, compressor may employ a rotary vane mechanism which forms one or more variable volume working pockets (known in the art as a rotary compressor), a mechanism of interleaved orbiting scroll members which form variable volume working pockets (known as a scroll compressor), or a mechanism or two or more interacting rotating screws which form variable volume working pockets (known in the art as a screw compressor).

2. Refrigeration System

Turning back to FIG. 1, refrigeration system 100 utilizes compressor 10 within a “vapor compression” type system, except that absorption and desorption of CO₂ from the ionic liquid is used as the motive force for fluid heat capacity, rather than phase change of the working fluid in the manner of a traditional vapor compression system. In particular, working fluid 18 absorbs heat Q_{IN} from a first space (e.g., a refrigerated space) as it passes through evaporator 106 and releases or “desorbs” CO₂ molecules from the ionic fluid. Working fluid 18 deposits heat Q_{OUT} into a second space (e.g., the ambient air outside the refrigerated space) as it passes through condenser 102 and binds or “resorbs” CO₂ molecules to the ionic fluid.

For purposes of the present disclosure, a “downstream” direction of flow refers to the direction that working fluid 18 flows during normal operation of refrigeration system 100. This flow direction is illustrated in FIG. 1 with arrows on the schematic fluid lines. An “upstream” direction is the opposite of the downstream direction.

Cofluid 18 is an “ionic” liquid in that it includes salts in which one or both of the cation and anion are large, and the cation has a low degree of symmetry. The resulting reduction in lattice energy renders the salts liquid at relatively low temperatures, such as between 20 and 100 degrees Celsius. Exemplary ionic liquids suitable for use in connection with the present disclosure include ionic liquids disclosed in U.S. Patent Application Publication No. 2016/0237333, entitled COMPOUNDS, COMPLEXES, COMPOSITIONS, METHODS AND SYSTEMS FOR HEATING AND COOLING, and in U.S. Patent Application Publication No. 2016/0288051, entitled CARBON DIOXIDE CAPTURE USING PHASE CHANGE IONIC LIQUIDS, the entire disclosures of which are hereby expressly incorporated herein by reference.

For example, ionic liquids for use in compressor 10 may comprise an anion represented by a formula (I):

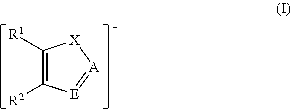

wherein X is N; A is N or CH; E is N or CH; and R¹ and R² are independently H, fluoro, chloro, bromo, ester, CN, CHO, NO₂, CF₃, or C₁₋₆ hydrocarbyl. In certain embodiments, none or one or both of R¹ or R² is a substituent other than H. In some embodiments, R¹ and R² are independently H, fluoro, chloro, bromo, NO₂, CHO, or methyl. In some embodiments, C₁₋₆ hydrocarbyl is methyl, and in others it can be methyl and/or ethyl.

Other suitable ionic liquids for use in compressor 10 comprise an anion represented by the formula (II):

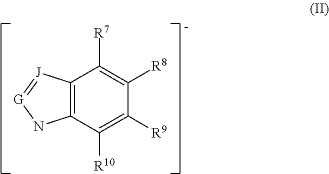

wherein G is CH; J is CH; and R⁷, R⁸, R⁹, and R¹⁰ areindependently H, Nom, chloro, bromo, ester, CN, CHO, NO₂, CF₃, or C₁₋₆ hydrocarbyl. In certain embodiments none or one of R⁷, R⁸, R⁹, or R¹⁰ is a substituent other than H. In some embodiments, R⁷ , R⁸, R⁹, and R¹⁰ are independently H, fluoro, chloro, bromo, NO₂, CHO, or methyl. In some embodiments, C₁₋₆ hydrocarbyl is methyl, and in others it can be methyl and/or ethyl.

In other embodiments, ionic liquids suitable for use in compressor 10 comprise an anion according to formula (Ia), wherein X is N, A is N, N—CO₂, or CH; E is N, N—CO₂, or CH; and R¹ and R² are independently H, fluoro, chloro, bromo, ester, CN, CHO, NO₂, CF₃, or C₁₋₆ hydrocarbyl:

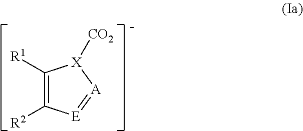

In certain embodiments, none or one or both of R¹ or R² is a substituent other than H. In some embodiments, R¹ and R² are independently H, fluoro, chloro, bromo, NO₂, CHO, or methyl. In some embodiments, C₁₋₆ hydrocarbyl is methyl, and in others it can be methyl and/or ethyl.

In other embodiments, ionic liquids suitable for use in compressor 10 comprise an anion according to formula (IIa), wherein G is CH; J is CH; and R⁷, R⁸, R⁹, and R¹⁰ are independently H, fluoro, chloro, bromo, ester, CN, CHO, NO₂, CF₃, or C₁₋₆ hydrocarbyl:

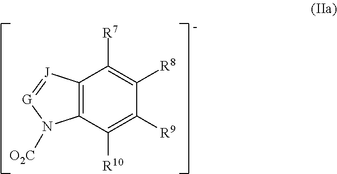

Possible cations of the ionic liquid include organic and inorganic cations. Examples of cations include quaternary nitrogen-containing cations, phosphonium cations, and sulfonium cations. Examples of quaternary nitrogen-containing cations include, but are not limited to, cyclic, aliphatic, and aromatic quaternary nitrogen-containing cations such as n-alkyl pyridinium, a dialkyl pyrrolidinium, a dialkyl imidazolium, or an alkylammonium of the formula R′_{4-X}NH_{X} wherein X is 0-3 and each R′ is independently an alkyl group having 1 to 18 carbon atoms. In some embodiments, unsymmetrical cations may provide lower melting temperatures. Examples of phosphonium cations include, but are not limited to, cyclic, aliphatic, and aromatic phosphonium cations. For example, the phosphonium cations include those of the formula R″_{4-X}PH_{X} wherein X is 0-3, and each R″ is an alkyl or aryl group such as an alkyl group having 1 to 18 carbon atoms or a phenyl group. Examples of sulfonium cations include, but are not limited to cyclic, aliphatic, and aromatic sulfonium cations. For example, the sulfonium cations include those of the formula R′″_{3-X}SH_{X} wherein X is 0-2 and each R′″ is an alkyl or aryl group such as an alkyl group having 1 to 18 carbon atoms or a phenyl group. Additional more specific examples may include, but are not limited to, ammonium, imidazolium, phosphonium, 1-butyl-3-methylimidazolium, 1-decyl-3-methylimidazolium, 1-dodecyl-3-methylimidazolium, 1-ethyl-3-butyl imidazolium, 1 -hexyl-3-methylimidazolium, 1-hexylpyridinium, 1-methy-3-butyl imidazolium, 1-methy-3-decyl imidazolium, 1-methy-3-dodecyl imidazolium 1-methy-3-ethyl imidazolium, 1-methy-3-hexadecyl imidazolium, 1-methy-3-hexyl imidazolium, 1-methy-3-octadecyl imidazolium, 1-methy-3-octyl imidazolium, 1-methy-3-propyl imidazolium, 1-octyl-3-methylimidazolium, 1-octylpyridinium, benzyl pyridinium, N-butyl pyridinium, ethyl pyridinium, and ethylene pyridinium.

Cofluid 18 may include varying amounts of gaseous CO₂, as required or desired for a particular application. In an exemplary embodiment, cofluid 18 contains as little as 0.5, 1.0 or 1.2 mol of CO₂ per kg of ionic liquid, and as much as 2.0, 2.2 or 2.5 mol of CO₂ per kg of ionic liquid, or may contain any amount of gaseous CO₂ within any range defined by any of the foregoing nominal values. In one exemplary embodiment, for example, cofluid 18 may contain about 1.95 mol of CO₂ per kg of ionic liquid.

In the illustrated embodiment, compressor 10 receives cofluid 18, which is a mixture of ionic liquid and gaseous CO₂, at inlet 32 (FIG. 2). Compressor 10 is activated to compress this mixture, as described in detail above, such that cofluid 18 is ejected at outlet 30 (FIG. 2) at an elevated pressure and temperature. In particular, the gaseous CO₂ of cofluid 18 is compressed while the substantially incompressible ionic liquid is pumped by the action of compressor 10. At the resulting elevated pressure, CO₂ molecules are induced to bind to the anions of the ionic fluid in cofluid 18, in an exothermic reaction that increases the temperature of cofluid 18.

In an exemplary embodiment, the cofluid pressure at inlet 32 of compressor 10 is about 5 bar (72 psi) and temperature is approximately 8 degrees Celsius. Compressor 10 raises the pressure to 25 bar (362 psi), which raises the temperature of cofluid 18 to about 20 degrees Celsius as a result of the binding action of CO₂ molecules to the ionic liquid. These pressures are typical of a “low pressure” system of the type normally associated with a traditional vapor compression system, as compared to a “high pressure” liquefied CO₂-based system operating at normal temperatures (e.g., room temperature of about 30 degrees Celsius), which utilizes pressures in excess of 74 bar (1073 psi). Of course, other pressures may be utilized in the present low-pressure system, as required or desired for a particular system application. For purposes of the present disclosure, a “low pressure” refrigeration system is one in which the maximum (e.g., high-side) pressure is below 50 bar (725 psi), 40 bar (580 psi), 30 bar (435 psi) or 20 bar (290 psi) for example. By contrast, maximum pressures experienced in CO2-based systems are typically substantially higher, such as between 83 bar (1200 psi) and 110 bar (1600 psi).

Compressor 10 discharges a flow of working fluid 18 to condenser 102. This flow may be visually monitored via sight glass 128, which offers a transparent flow line section to allow an operator to view the fluid flow. The flow may also be subject to high-pressure cutout 126, which may limit the incoming pressure to compressor 10. In an exemplary embodiment, this incoming pressure limit may be about 35 bar (about 500 psi).

Condenser 102 is a heat exchanger operable to discharge heat Q_{OUT} to the environment around condenser 102, such as the ambient air around refrigeration system 100. In particular, condenser 102 receives the flow of high-pressure working fluid 18, which is warmer than the ambient air around condenser 102. This temperature differential causes heat Q_{OUT} to be withdrawn from working fluid 18. In an exemplary embodiment, condenser 102 may be selectively acted upon by fan 104 to increase the amount of heat Q_{OUT} discharged from condenser 102.

After passing through condenser 102, the flow of cooler working fluid 18 passes through suction line heat exchanger (SLHE) 112 which cools working fluid 18 further, as described in detail below. Fluid 18 progresses on to expansion valve 110, where the pressure of working fluid 18 is allowed to drop. This drop in pressure allows CO₂ molecules to be released from the anions of the ionic liquid, an endothermic reaction that further cools working fluid 18. At this point, the temperature of working fluid 18 is below the ambient temperature of the conditioned space. In an exemplary embodiment, the set-point temperature for the conditioned space served by refrigeration system 100 may be as low as zero degrees Celsius, 3 degrees Celsius or 5 degrees Celsius, or as much as 7 degrees Celsius, 10 degrees Celsius or 15 degrees Celsius, or may be any set point within any range defined by any of the foregoing values.

The cooled working fluid 18 discharged from expansion valve 110 is passed on to evaporator 106, which is a heat exchanger operable to absorb heat Q_{IN} into working fluid 18 from the evaporator's ambient environment (e.g., the interior of a conditioned space such as refrigerator or freezer). In an exemplary embodiment, a water flow is passed through evaporator 106 to effect heat exchange from relatively warm water to the cooler working fluid 18, such that chilled water is discharged from evaporator 106 and used to cool the conditioned space in a conventional manner. In an exemplary embodiment, water flow meter 124 may be provided to monitor the volume of water passing through evaporator 106. By measuring this water flow volume and the temperature of the flow, an estimation of heat transfer capacity of refrigeration system 100 can be made.

The working fluid 18 discharged from evaporator 106, having absorbed heat Q_{IN} but remaining relatively cool, is sent back to SLHE 112. This flow of cool working fluid 18 absorbs more heat from the flow from condenser 102 passing through SLHE, which serves to “pre-cool” working fluid 18 before it encounters expansion valve 110. This pre-cooling action allows the output temperature from expansion valve to be reduced, therefore increasing the efficiency of refrigeration system 100.

Upon discharge from SLHE 112, working fluid 18 is transmitted to receiver 108, which separates the gaseous flow of CO₂ from the liquid flow of ionic liquid. The volume of each flow may then be altered (i.e., adjusted to increase or decrease the flow volume) using CO₂ flow valve 114 and liquid flow valve 116, respectively. In this way, flow valves 114 and/or 116 can be used to achieve a desired flow rate of each constituent of the cofluid 18 and, therefore, a desired overall constituency of the cofluid 18. These flow rates can be measured and monitored using CO₂ flow meter 120 and liquid flow meter 122 disposed downstream of the CO₂ flow valve 114 and liquid flow valve 116, respectively. This tailored cofluid flow, which will always include at least a minimum threshold amount of liquid flow, is then sent to compressor 10 to begin the cycle anew.

Advantageously, refrigeration system 100 operates at the relatively low pressures of a traditional vapor-compression system, which allows for inexpensive production and reliable operation using commercially available components. In contrast, refrigeration systems using liquefied CO₂ operate at much higher pressures, requiring specialized and/or expensive equipment to contain the high pressures. At the same time, refrigeration system 100 uses the CO₂-based working fluid 18, which if exposed to ambient temperatures and pressures will only release a small amount of relatively harmless CO₂ gas to the atmosphere, rather than HFC gasses which carry a much large potential for damaging environmental effects.

Thus, refrigeration system 100, including compressor 10 and cofluid 18, operates as a low-pressure, CO₂-based refrigeration system which realizes the benefits of CO₂ as a working fluid without the costs associated with a traditional high-pressure liquefied CO₂ system.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A refrigeration system comprising:
a compressor having a housing and an electric motor hermetically sealed within the housing;
a condenser;
an expansion valve;
an evaporator; and
a quantity of working fluid comprising an electrically conductive ionic liquid and carbon dioxide, the working fluid circulatable through a series of fluid conduits interconnecting the compressor, the condenser, the evaporator and the expansion valve.

2. The refrigeration system of claim 1, wherein the compressor raises a pressure of the quantity of working fluid to 50 bar or less.

3. The refrigeration system of claim 1, further comprising a lubrication system having a lubrication inlet within the housing of the compressor and a lubrication outlet in fluid communication with the electric motor, such that the lubrication system circulates the working fluid around moving parts of the electric motor.

4. The refrigeration system of claim 3, wherein the working fluid is accumulated in a sump region at the bottom of the housing, and the lubrication system comprises a suction tube having a lower end submerged in the quantity of working fluid in the sump region, the suction tube operable to draw the ionic liquid of the working fluid into contact with moving parts of the compressor.

5. The refrigeration system of claim 4, wherein the quantity of working fluid includes a nonfunctional diluent operable to decrease the viscosity of the ionic liquid without altering the electrical conductivity of the ionic liquid.

6. The refrigeration system of claim 5, wherein the viscosity of the working fluid containing the nonfunctional diluent is between 30 centistoke and 300 centistoke.

7. The refrigeration system of claim 5, wherein the nonfunctional diluent is tetraethylene glycol dimethyl ether.

8. The refrigeration system of claim 1, wherein the compressor includes an electrical terminal passing through the housing and electrically connected to the electric motor, the electrical terminal electrically isolated from the working fluid at the interior of the housing.

9. The refrigeration system of claim 1, wherein the electric motor of the compressor comprises:
a stator having a plurality of electrically conductive windings engaged with a winding retainer;
a rotor received within the stator;
an electrically insulative coating on the windings, the coating disposed between the windings and the interior of the housing such that the windings are electrically isolated from the working fluid.

10. The refrigeration system of claim 1, further comprising a suction-line heat exchanger positioned to receive a first flow of the working fluid from the condenser and a second flow of the working fluid from the evaporator, and to discharge the first flow to the expansion valve and the second flow to the compressor, the first flow being in heat exchange relationship with the second flow while in the suction-line heat exchanger.

11. The refrigeration system of claim 10, further comprising a receiver functionally interposed between the suction-line heat exchanger and the compressor, the receiver operable to separate a gaseous flow of the carbon dioxide from a liquid flow of the ionic liquid.

12. The refrigeration system of claim 11, further comprising:
a CO₂ flow valve operably interposed between the receiver and the compressor, the CO₂ flow valve operable to increase or decrease a volume of flow of the carbon dioxide portion of the working fluid; and
a liquid flow valve operably interposed between the receiver and the compressor, the liquid flow valve operable to increase or decrease a volume of flow of the ionic liquid portion of the working fluid.

13. The refrigeration system of claim 12, further comprising:
a CO₂ flow meter operable to measure a nominal flow rate of the carbon dioxide downstream of the CO₂ flow valve; and
a liquid flow meter operable to measure a nominal flow rate of the ionic liquid downstream of the liquid flow valve.

14. A compressor for use with an electrically conductive working fluid, the compressor comprising:
a housing having an inlet and an outlet; and
an electric motor hermetically sealed within the housing and electrically isolated from the interior of the housing.

15. The compressor of claim 14, further comprising a quantity of working fluid comprising an electrically conductive ionic liquid received within the housing and in contact with the electric motor.

16. The compressor of claim 15, wherein the quantity of working fluid includes carbon dioxide.

17. The compressor of claim 16, wherein the quantity of working fluid includes a nonfunctional diluent operable to decrease the viscosity of the ionic liquid without altering the electrical conductivity of the ionic liquid.

18. The compressor of claim 14, wherein the electric motor includes windings having a coating thereupon, such that the coating is disposed between the windings and the interior of the housing such that the windings are electrically isolated from the interior of the housing.

19. The compressor of claim 18, further comprising:
a terminal housing sealingly connected to a wall of the housing;
an electrical terminal passing through the terminal housing and electrically connected to the electric motor; and
insulation within the terminal housing and surrounding the electrical terminal, such that the electrical terminal is electrically isolated from the interior of the housing.

20. The compressor of claim 14, wherein the compressor has a maximum pressure output of no greater than 50 bar.

21. A refrigeration system comprising:
a compressor comprising:
a housing having an inlet and an outlet, the housing forming a hermetically sealed chamber which does not admit fluid passage except through the inlet and the outlet;
an electric motor enclosed within the hermetically sealed chamber of the housing, the motor having a plurality of motor windings which are electrically isolated from the hermetically sealed chamber;
a piston assembly enclosed within the hermetically sealed chamber of the housing and drivingly coupled to the motor, the piston assembly operable to increase a pressure within the hermetically sealed chamber from a suction pressure at the inlet to a discharge pressure at the outlet; and
at least one electrical having an external connector portion outside the housing electrically coupled to an internal connector portion within the hermetically sealed chamber, the internal connector portion electrically isolated from the hermetically sealed chamber;
a condenser;
an expansion valve;
an evaporator; and
a quantity of working fluid comprising an electrically conductive ionic liquid and carbon dioxide, the working fluid circulatable through a series of fluid conduits interconnecting the compressor, the condenser, the evaporator and the expansion valve.

22. The refrigeration system of claim 21, wherein the inlet and the outlet of the housing of the compressor respectively receive and discharge both the electrically conductive ionic liquid and the carbon dioxide of the working fluid.
